(19) United States
(12) Patent Application Publication
(10) Pub. No.: US 2022/0272429 A1
(43) Pub. Date: Aug. 25, 2022

(54) Speaker System

(71) Applicant: BOCO INC., Tokyo (JP)

(72) Inventor: Hataaki Sha, Tokyo (JP)

(21) Appl. No.: 17/632,561

(22) PCT Filed: Aug. 20, 2020
(86) PCT No.: PCT/JP2020/031446

§ 371 Date: Apr. 12, 2022

(30) Foreign Application Priority Data
Aug. 20, 2019 (JP) 2019-150204

(51) Int. Cl. H04R 1/02; H04R 1/28

(52) U.S. Cl. CPC H04R 1/02; H04R 1/2811; H04R 2201/40; H04R 2420/07

(57) ABSTRACT

A speaker system is provided with: a plurality of boxes; a plurality of vibration output devices which output vibrations by using a vibrating body for converting an electric signal into vibrations; and a voice transmission unit which transmits voice information to the vibration output devices. The plurality of boxes have mutually different sizes, and comprise one box (n) in which other box (n+1) smaller by one size than the box (n) is accommodated successively, whereby all the boxes can be accommodated in the largest box. In the speaker system, when the boxes are arranged apart from each other, the vibration output devices can be installed in the respective boxes, thereby allowing the boxes to function as speakers. Thus, it is possible to emit voice from the respective boxes on the basis of voice information from the voice transmission unit.

### TECHNICAL FIELD

The present invention relates to a speaker system.

### BACKGROUND

To spread sound within a particular area in the open-air, a plurality of loudspeakers are to be installed apart from each other in the area to be addressed (see Japanese Unexamined Patent Application Publication No. 1998-93514 (JP-A-1998-93514), for example). Also, for events etc. that are held in outdoor-mobile venues, packable or transportable speakers have been used (see Japanese Unexamined Patent Application Publication No. 2009-118376 (JP-A-2009-118376), for example).

However, a traditional speaker is large and heavy because of a speaker unit installed inside a housing of the speaker. Thus, even if the speaker is transportable, it costs a lot of time and effort to install the plurality of speakers apart from each other in a large area. Also, when unused, the speakers take up a large space for storage. Moreover, the speakers are expensive, and thus building a speaker system using the plurality of speakers raises the cost. In particular, when installing the speakers over a large area such as an evacuation site for a disaster, it is sometimes difficult to find power sources for the speakers or places to install the speakers.

The present invention is made in view of above issues, and it is an object of the present invention to provide a low-cost speaker system that is easy to transport and install, and can be compactly stored.

### SUMMARY OF THE DISCLOSURE

To achieve the above object, an aspect of the present invention is a speaker system including a plurality of boxes, a plurality of vibration output devices, each of which outputs vibrations by using a vibrating body for converting electric signals into vibrations, and a voice transmission unit that transmits voice information to the vibration output devices. The plurality of the boxes differ from each other in size: the first box accommodates the second box that is one-size smaller than the first box and so forth, thereby the largest box can accommodate all the boxes. When the boxes are disposed apart from each other, the vibration output device is installed on each of the boxes so that the box can function as a speaker, where each of the boxes can emit voice based on the voice information from the voice transmission unit.

The present invention uses the vibration output device that outputs vibrations by using the vibrating body for converting electric signals into vibrations. Thus, the box can emit sound by installing the vibration output device on each of the plurality of boxes, with the vibration body directly vibrating each of the boxes. That is, each of the boxes can function as a speaker. Also, with the plurality of boxes disposed apart from each other emitting the voice, the sound can spread over the particular area.

The box on which the vibration output device is installed is smaller and lighter than traditional speakers. Thus, when installing the plurality of boxes apart from each other in a large area, the speakers can be easily transported and installed. In addition, the boxes with the vibration output devices cost less than traditional speakers, and thus it is possible to build a low-cost speaker system in which the plurality of boxes function as speakers.

In the present invention, the boxes having different sizes from each other are accommodated successively by accommodating the one-size smaller box inside another, thereby the largest box can accommodate all the boxes. This makes it possible to compactly put together the speaker system and to make storage space smaller when being unused. Also, transportation between a storage site and a usage site is easy.

A hole may be formed on at least one side face of the box. This can control acoustics of the voice emitted from the box.

A lid, which can be opened, may be formed on one face of the box. Preferably, when taking out the box, the lid is opened so that the box inside can be taken out, and, when the box is used as a speaker, the lid can be closed.

In this way, it is easy to take or put the box that is one-size smaller than the other box out of or into the other box. Also, when the lid is closed, the entire box including the lid can vibrate to generate the sound.

The vibration output device may include a wireless receiver, for example, and can wirelessly receive voice signals from the voice transmission unit.

The vibration output device and the voice transmission unit may also be connected by cable.

If the vibration output device can wirelessly receive voice signals, wiring or the like is unnecessary. If the vibration output device and the voice transmission unit are connectable by cable, it is possible to transmit or receive voice signals when the vibration output device is too far from the voice transmission unit to an extent that the wireless communication is impossible.

It is preferable that the smallest box can accommodate the plurality of vibration output devices and the voice transmission unit.

This can put together the boxes, the vibration output devices, and the voice transmission unit, and thus it is possible to store the speaker system more compactly.

It is preferable that the smallest box includes a connector for charging, and the plurality of vibration output devices can be charged at once while being accommodated inside the smallest box.

In this way, the vibration output devices and the voice transmission unit can be charged without being taken out of the box.

The present invention can provide a low-cost speaker system that is easy to transport and install, and can be compactly stored.

### BRIEF DESCRIPTION OF THE DRAWINGS

FIG. 1 is a schematic view showing a speaker system 1.

FIG. 2 is a perspective view of a box 3.

FIG. 3A is a perspective view showing the smallest box 3-8.

FIG. 3B is an arrangement plan view inside the box 3-8.

FIG. 4A is a side view of a vibration output device 5.

FIG. 4B is a side view of a vibration output device 5a.

FIG. 5 is a view showing a state in which the speaker system 1 is in use.

FIG. 6A is a view showing the box 3 on which the vibration output device 5 is installed.

FIG. 6B is a view showing an example in which a waterproof cover 23 is used.

FIG. 7A is a view showing an example in which a waterproof container 25 is used.

FIG. 7B is a view showing an example in which the vibration output device 5 is installed inside the box 3.

FIG. 8 is a view showing a sate in which a speaker system 1a is in use.

FIG. 9 is a view showing an accommodation method in the box 3.

### DETAILED DESCRIPTION

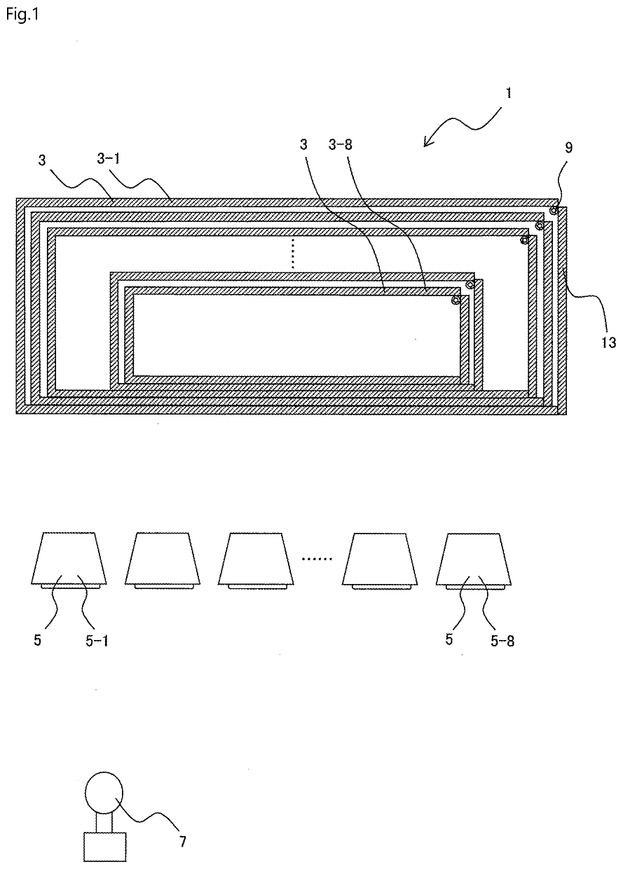

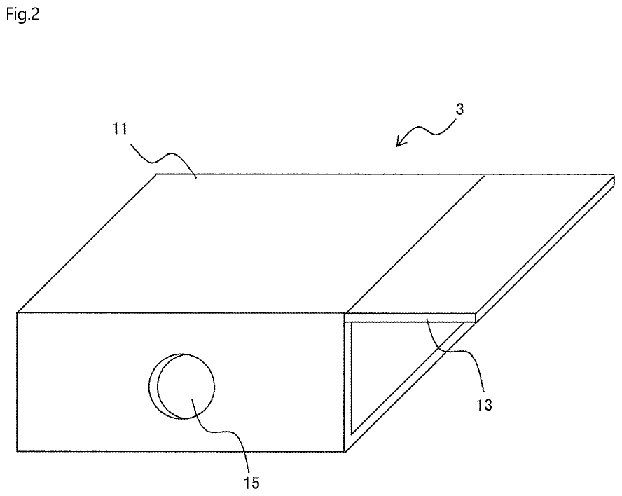

Hereinafter, preferable embodiments of the present invention will be described with reference to the accompanying drawings. FIG. 1 is a schematic view showing a speaker system 1. FIG. 2 is a perspective view of a box 3. The speaker system 1 includes the plurality of boxes 3, a plurality of vibration output devices 5, a voice transmission unit 7, and so on. The box 3 and the vibration output device 5 are installed being paired with each other, and the number of such pairs is determined according to a size of an area to be used or a purpose. FIG. 1 shows an example in which there are eight each of the boxes 3 and the vibration output devices 5.

As shown in FIG. 1, the plurality of boxes 3 differ from each other in size, and the box 3-n (n represents a natural number) can successively accommodate the box 3-(n+1), which is one-size smaller than the box 3-n. That is, in the example shown in FIG. 1, the largest box 3-1 can accommodate the boxes 3-2, 3-3, . . . 3-8. The box 3 is made of material such as wood or acrylic resin that is hard to an extent that can vibrate and function as a speaker.

The box 3 is a rectangular parallelepiped, for example, with one face of which is formed with a lid 13 that can be opened. A hinge 9 joins the lid 13 to a main body 11. By opening the lid 13 of the box 3-n, the one-size smaller box 3-(n+1) can be easily taken out of or put into the box 3-n. The box 3 has a hole 15 formed on at least one side face of the main body 11. The hole 15 may be formed on the lid 13. Alternatively, the box 3 may not have the lid 13.

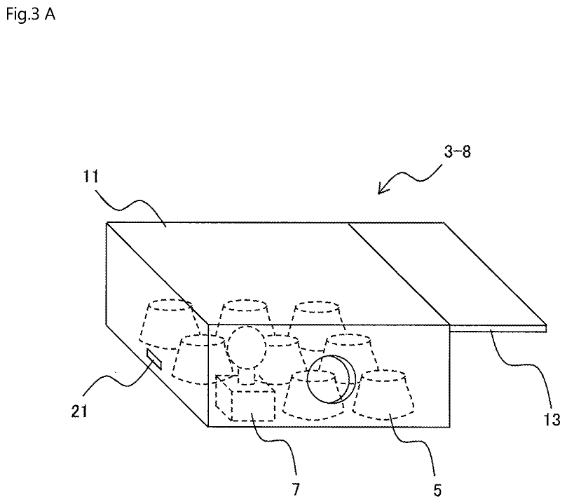

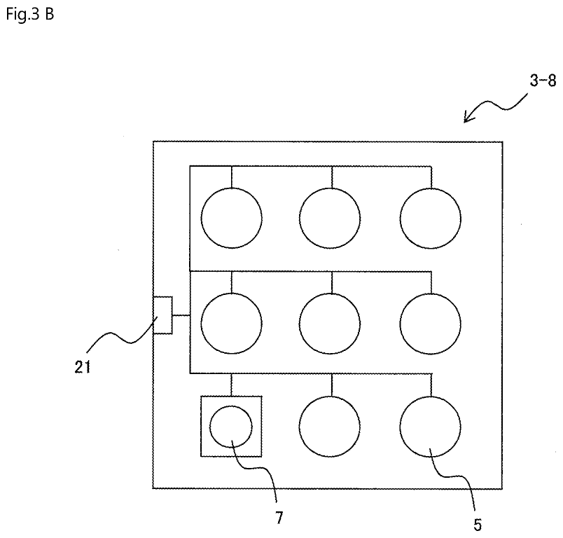

FIG. 3A is a perspective view showing the smallest box 3-8. As shown in FIG. 3A, the smallest box 3-8 is provided with a connector 21 for charging, as necessary. The box 3-8 can accommodate all the vibration output devices 5 and the voice transmission unit 7.

FIG. 3B is an arrangement plan view inside the box 3-8. As shown in FIG. 3B, the box 3-8 has a structure that can transmit electric power from the connector 21 to all the vibration output devices 5 and the voice transmission unit 7. Thus, by connecting a charging cable to the connector 21, all the vibration output devices 5 and the voice transmission unit 7 can be charged at once easily without taking the vibration output devices 5 and the voice transmission unit 7 out of the box 3.

Although not shown in the drawings, it is preferable that each of the boxes 3-1, . . . , 3-7, which are larger than the box 3-8, has a hole for a cable to pass through. With the cable holes provided and the largest box 3-1 accommodating the rest of the boxes 3 inside, the charging cable can be passed through the cable hole of each of the boxes 3 and connected to the connector 21 of the box 3-8. However, such the connector and the cable holes, etc. are optional.

The voice transmission unit 7 is a microphone, for example. The voice transmission unit 7 transmits voice signals, such as acoustic electric signals, as sound information to the vibration output device 5. The voice transmission unit 7 includes an internal communication unit for wireless communication.

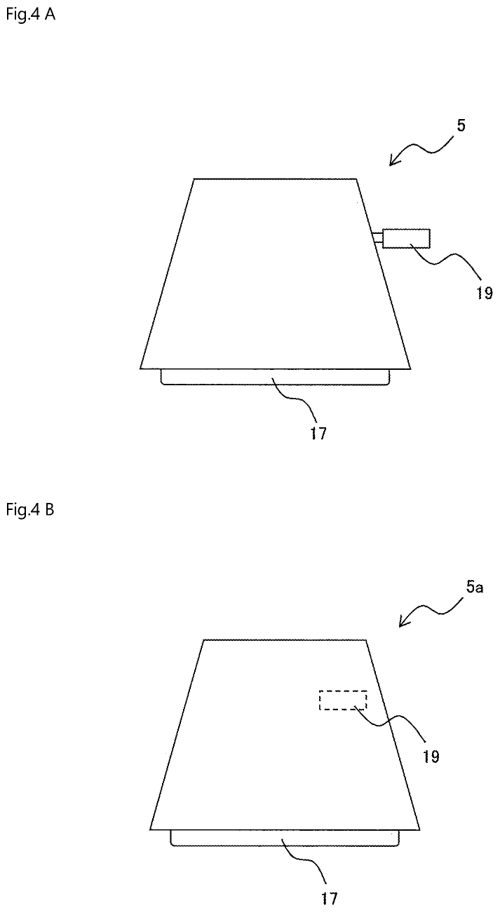

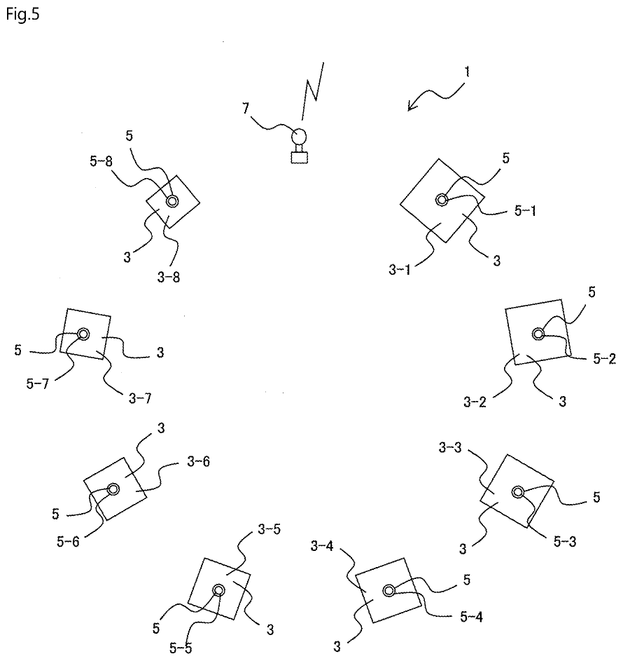

FIG. 4A is a side view of the vibration output device 5. The vibration output device 5 is attached with an external wireless receiver 19. The vibration output device 5 can receive, through the wireless receiver 19, the voice signals transmitted wirelessly from the voice transmission unit 7. A vibrating body 17 is exposed on a lower part of the vibration output device 5. The vibrating body 17 converts the electric signals received from the voice transmission unit 7 into vibrations. That is, the vibration output device 5 is not a normal speaker that emits sound waves by air vibration, but is a so-called vibration speaker, like a bone-conduction speaker, that outputs vibrations and is capable of vibrating an object while being contact with the object.

FIG. 4B is a side view of a vibration output device 5a. The vibration output device 5a includes the internal wireless receiver 19. The speaker system 1 may use the vibration output device 5a in place of the vibration output device 5.

When storing the speaker system 1, the largest box 3 accommodates the rest of the boxes 3. Also, the smallest box 3 accommodates all the vibration output devices 5 and the voice transmission unit 7.

Next, a method for using the speaker system 1 will be described. FIG. 5 is a view showing a state in which the speaker system 1 is in use. FIG. 5 is an upper plan view of the speaker system 1 in use. The speaker system 1 may be used outdoors such as in an open space or in a ground, or indoors.

To use the speaker system 1, firstly, the speaker system 1 is charged as necessary in a storage state. That is, the charging cable is connected to the connector 21 while the largest box 3 accommodates the rest of the boxes 3 and the smallest box 3 accommodates all the vibration output devices 5 and the voice transmission unit 7.

Then, the lid 13 is opened one at a time repeatedly in turn from the largest box 3-1 to take out the one-size smaller box 3, separating the boxes 3-1, 3-2, . . . , 3-8. Also, the lid 13 of the smallest box 3-8 is opened to take out all the vibration output devices 5 and the voice transmission unit 7 from inside.

Next, the plurality of boxes 3-1, 3-2, . . . , 3-8 are disposed apart from each other as shown in FIG. 5. The vibration output devices 5-1, 5-2, . . . , 5-8 are installed on a top face of each of the boxes 3-1, 3-2, . . . , 3-8. Also, the voice transmission unit 7 is installed at a position so as to allow wireless transmission and reception of the voice information between the voice transmission unit 7 and all the vibration output devices 5. The speaker system 1 uses wireless communication for transmitting and receiving the voice information, and thus there is no need to install cables or the like between the vibration output devices 5 and the voice transmission unit 7.

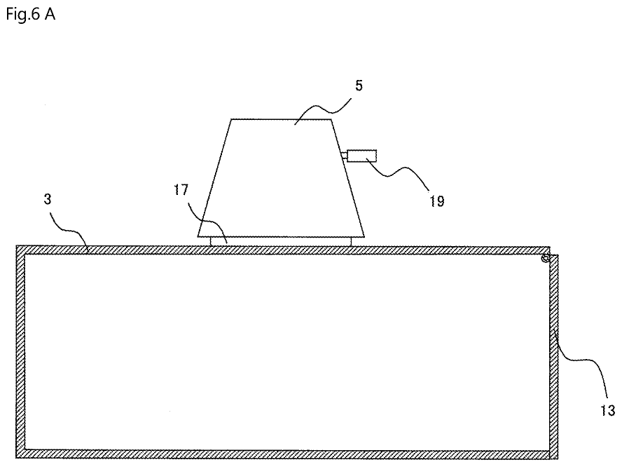

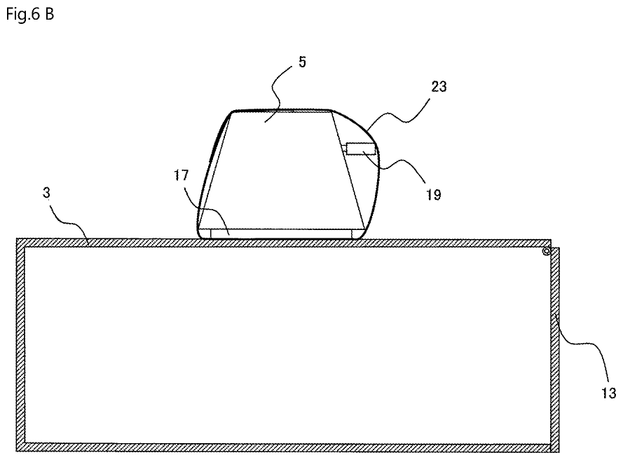

FIG. 6A is a view showing the box 3 on which the vibration output device 5 is installed, and is a cross sectional view cut along a vertical face of the box 3. As shown in FIG. 6A, the lid 13 of the box 3 is closed when the speaker system 1 is in use. Also, the vibration output device 5 is installed on the top face of the box 3 with the vibration body 17 on a lower side of the vibration output device 5. That is, the vibration body 17 is in contact with the box 3.

When the speaker system 1 is in use, a user inputs voice into the voice transmission unit 7, which is a microphone or the like, and then the voice transmission unit 7 wirelessly transmits the voice information to each of the vibration output devices 5. Each of the vibration output devices 5 receives the voice signals through the wireless receiver 19 and outputs vibrations based on the received voice information through the vibrating body 17. The vibrations of the vibrating body 17 are conducted to the box 3, and the box 3 emits the voice according to such vibrations. That is, installing the vibration output device 5, which is a vibration speaker, on the box 3 makes the each box 3 function as a speaker. At this time, with the lid 13 being closed, the entire box 3 including the lid 13 can vibrate to generate sound. Also, forming the appropriate hole 15 on the box 3 can improve acoustics of the voice emitted from the box 3.

As described above, the present embodiment uses the vibration output device 5 for outputting vibrations through the vibrating body 17 that converts electric signals to vibrations, and the vibration output device 5 is installed on each of the plurality of boxes 3 to directly vibrate the boxes 3 so that each of the boxes 3 can function as a speaker. Also, by disposing the plurality of boxes 3 apart from each other to emit voice sound, the sound can be spread over the particular area.

The boxes 3 on which the vibration output devices 5 are installed are smaller and lighter than traditional speakers, and are easily transported and installed when being disposed apart from each other in a large area. Also, the boxes 3 installed with the vibration output devices 5 are cheaper than traditional speakers, and thus the speaker system 1 in which the plurality of boxes 3 function as speakers can be built at low cost. Also, while traditional speakers are directive in sound emission, the box 3 installed with the vibration output device 5, which is a vibration speaker, can emit sound in all directions in principle. Thus, voice can be heard clearly in a large area.

In the present embodiment, the box 3 successively accommodates the one-size smaller box 3, thereby the largest box 3 can accommodate the rest of the boxes 3. Also, the smallest box 3 can accommodate the plurality of vibration output devices 5 and the voice transmission unit 7. Thus, the speaker system 1 can be put together compactly without taking up much space for storage when unused. Also, transportation between the storage site and the usage site is easy.

As above, the speaker system 1 is low cost and easy to store, transport, and install. Thus, the speaker system 1 is appropriate for an emergency-use speaker that is stored inside a storeroom at normal times and used in evacuation sites or the like at the time of disaster, for example.

When used outdoors, the speaker system 1 can be applied with a waterproof protection as necessary. FIG. 6B is a view showing an example in which a waterproof cover 23 is used. In the example shown in FIG. 6B, the waterproof cover 23 covers the vibration output device 5. The waterproof cover 23 may be food wrap film etc., for example. No waterproofing of the box 3 may not disrupt the function of the speaker system 1, and thus the speaker system 1 can be used outdoors in the rain by waterproofing only the vibration output devices 5.

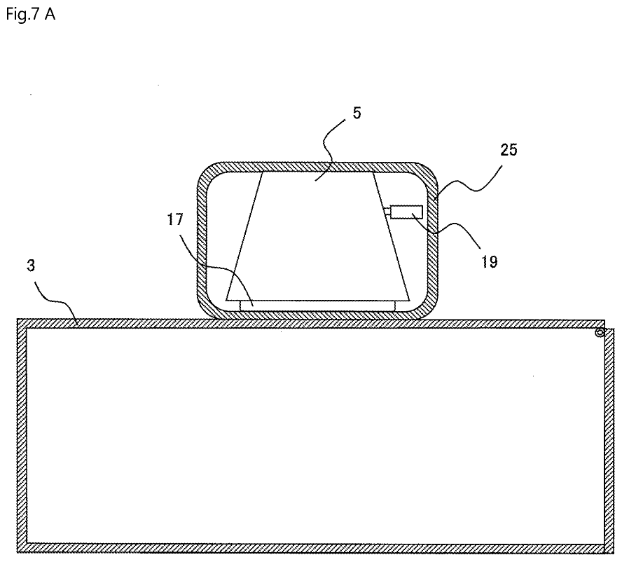

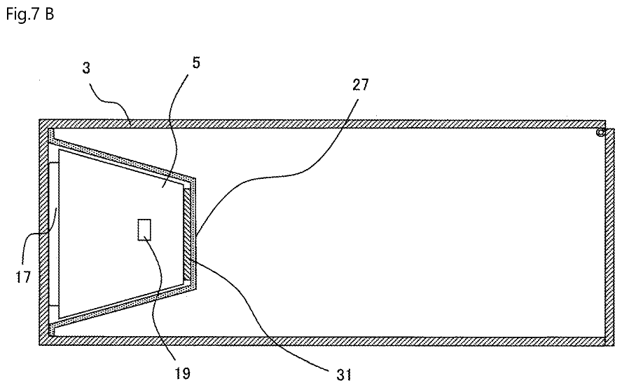

FIG. 7A is a view showing an example in which a waterproof container 25 is used. In the example shown in FIG. 7A, the waterproof container 25 accommodates the vibration output device 5. The waterproof container 25 is made of material having certain rigidity, such as hard resin. The vibration output device 5 is fixed to the waterproof container 25 by using a fixing member, which is not shown in the drawing, so as not to obstruct vibrations of the vibrating body 17 while the vibrating body 17 is still in close contact with a bottom face of the waterproof container 25. Also, the vibration output device 5 is installed on the top face of the box 3 with a side of the waterproof container 25, which is in contact with the vibrating body 17, as a lower face.

FIG. 7B is a view showing an example in which the vibration output device 5 is installed inside the box 3. In the example shown in FIG. 7B, the box 3 accommodates the vibration output device 5 inside. The vibration output device 5 is fixed to the box 3 by using an attachment tool 27 so as to make the vibrating body 17 contact closely with a face that is other than the bottom face of the box 3 and not to obstruct vibrations of the vibrating body 17. An elastic member 31 may be provided between the vibration output device 5 and the attachment tool 27, for example, allowing the vibrating body 17 to vibrate while being pressed by the attachment tool 27, and thus vibrations of the vibrating body 17 are not obstructed. In the examples shown in FIG. 7A and FIG. 7B, waterproofing of the box 3 is also unnecessary, and the speaker system can be used outdoors in the rain without any problems by waterproofing only the vibration output device 5.

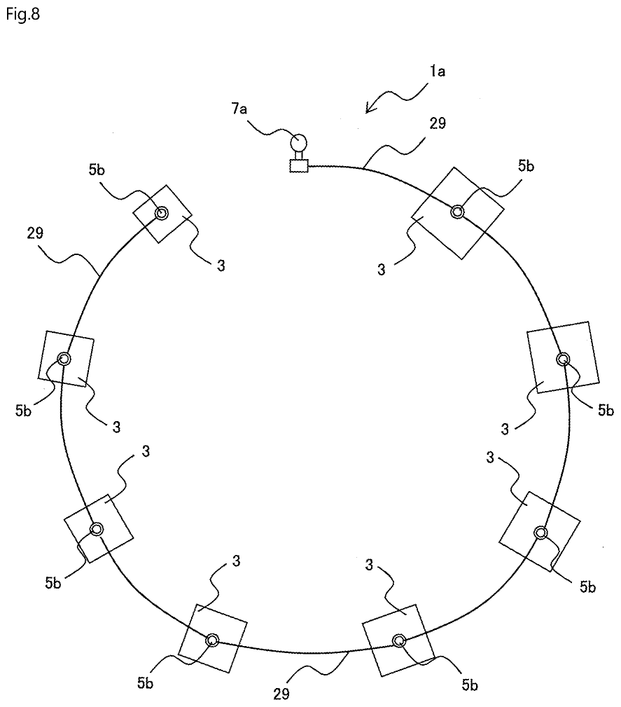

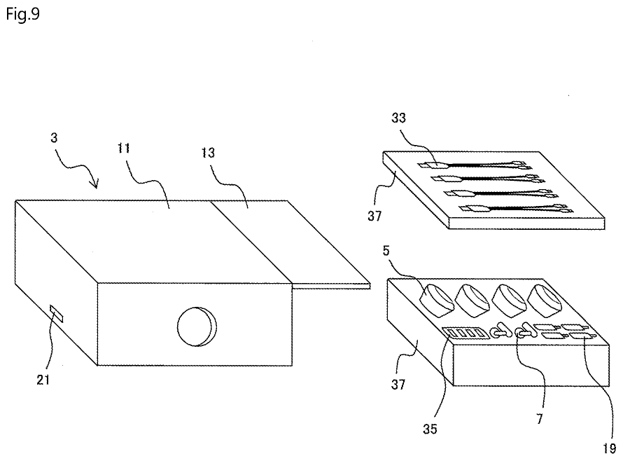

Although the present embodiment uses wireless communication for the communication between the vibration output devices 5 and the voice transmission unit 7, wired communication may also be used. FIG. 8 is a view showing a state in which a speaker system 1a is in use. As shown in FIG. 8, the speaker system 1a uses a vibration output device 5b in place of the vibration output device 5, and a voice transmission unit 7a in place of the voice transmission unit 7. The wireless receiver 19 is not provided in the vibration output device 5b, and the vibration output device 5b is connected with a cable 29. The voice transmission unit 7a has no internal communication unit for wireless communication but is connected with the cable 29. In the speaker system 1a, the voice information from the voice transmission unit 7a is transmitted to the vibration output device 5b via the cable 29. By connecting the vibration output device 5b and the voice transmission unit 7a with cables, the voice signals can be transmitted and received even when the vibration output device 5b is too far from the voice transmission unit 7a to an extent that the wireless communication is impossible.

Although FIG. 3 shows a state in which the smallest box 3 accommodates the vibration output devices 5 and the voice transmission unit 7, the box 3 may accommodate other items. FIG. 9 is a view showing an accommodation method in the box 3. In an example shown in FIG. 9, the smallest box 3 can accommodate the vibration output devices 5, the voice transmission unit 7, the wireless receivers 19, charging cables 33, and a charger 35 that are set on a cushioning material 37 for packaging.

For the speaker system shown in FIG. 9, a method for charging the vibration output devices 5 and the voice transmission 7 is selectable according to circumstances. That is, the vibration output devices 5 and the voice transmission 7 may be charged together by using the connector 21 while being accommodated inside the smallest box 3, or may be taken out of the box 3 and charged individually by using the charging cable 33 and the charger 35.

Although the preferred embodiments of the present invention have been described referring to the attached drawings, the technical scope of the present invention is not limited to the embodiments described above. It is obvious that persons skilled in the art can think out various examples of changes or modifications within the scope of the technical idea disclosed in the present application, and it will be understood that they naturally belong to the technical scope of the present invention.

For example, the box 3 is not limited to a rectangular parallelepiped but may be a rectangular column or a circular column, etc. Also, the lid 13 may be formed at a position other than the side face. The lid 13 is not limited to have a structure that can be opened and closed by means of the hinge 9 but may have a structure in which the lid 13 is separated from the main body 11 when opened. The communication method between the vibration output device and the voice transmission unit may be switchable between wireless communication and wired communication.

1. A speaker system comprising:
a plurality of boxes;
a plurality of vibration output devices, each of which outputs vibrations by using a vibrating body for converting electric signals into vibrations; and
a voice transmission unit for transmitting voice information to the vibration output devices, wherein:
the plurality of boxes differ from each other in size with each box accommodating the next that is smaller in size such that the largest box accommodates all boxes of the plurality of boxes,
the vibrating body of the vibration output device is in contact with each of the plurality of boxes such that the box can function as a speaker,
when the plurality of boxes are disposed apart from each other, each of the plurality of boxes can emit voice based on the voice information from the voice transmission unit.

2. The speaker system according to claim 1, wherein a hole is formed on at least one side face of the box.

3. The speaker system according to claim 1, wherein:
a lid, which can be opened, is formed on one face of the box,
when taking out the box, the lid is opened so that the box inside can be taken out, and
when the box is used as a speaker, the lid can be closed.

4. The speaker system according to claim 1, wherein:
the vibration output device comprises a wireless receiver, and
the vibration output device can wirelessly receive voice signals from the voice transmission unit.

5. The speaker system according to claim 1, wherein the vibration output device and the voice transmission unit can be connected by cable.

6. The speaker system according to claim 1, wherein the smallest box can accommodate the plurality of vibration output devices and the voice transmission unit.

7. A speaker system comprising:
a plurality of boxes;
a plurality of vibration output devices, each of which outputs vibrations by using a vibrating body for converting electric signals into vibrations; and
a voice transmission unit for transmitting voice information to the vibration output devices, wherein:
the plurality of the boxes differ from each other in size with each box accommodating the next that is smaller in size such that the largest box accommodates all boxes of the plurality of boxes,
when the plurality of boxes are disposed apart from each other, the vibration output device is installed on each of the boxes so that the box can function as a speaker,
each of the plurality of boxes can emit voice based on the voice information from the voice transmission unit,
the smallest box can accommodate the plurality of vibration output devices and the voice transmission unit, and
the smallest box comprises a connector for charging, and the plurality of vibration output devices can be charged at once while being accommodated inside the smallest box.
